(19) United States
(12) Patent Application Publication
(10) Pub. No.: US 2006/0262144 A1
(43) Pub. Date: Nov. 23, 2006

(54) Image Rotation across Multiple Video and/or Graphic Displays

(75) Inventor: Paul Edward Harris, Manalapan, NJ (US)

Correspondence Address: Mr.Paul Edward Harris, 205 Commercial Court, Morganville, NJ, 07751, US

(73) Assignee: Mr. Paul Edward Harris, Morganville, NJ (US)

(21) Appl. No.: 10/908,680

(22) Filed: May 23, 2005

(51) Int. Cl. G09G 5/00

(52) U.S. Cl. 345/649; 345/660

(57) ABSTRACT

An electronic device providing scaling and rotation capabilities for use with multiple displays. The result will create a larger image by zooming, positioning and cropping into specific areas of each display.

The invention relates to the process of manipulating image(s) from a video or graphic source and being viewed across multiple displays that have been mounted in a way where the vertical size is larger than the horizontal. This is also referred to as a video wall, but with the displays mounted vertically (portrait). This allows for new effects if the incoming signal(s) are rotated to accommodate the mounting orientation of the displays.

The electronic device would need to have the ability to scale (resize image), and rotate. Zooming, positioning and cropping into a specific location of the image for each display will create a larger image across the many displays. Using this invention in a single device multiple times allows the creation of a video wall processor which is capable of achieving rotated images to make up a single image across multiple vertically mounted displays with unlimited rows and/or columns. The addition of a matrix will increase the effectiveness of such a device to direct multiple inputs as needed. The invention can also be used independently in a device so that multiple devices can work together to achieve the effect of the vertically mounted video wall. This would allow the circuit to be contained in the display itself or as smaller independent devices that could be on a 1:1 ratio with each display.

Definition List 1

| Term | Definition |
|---|---|
| Input Signal | A video or graphic image to be processed. The |
| | input signal can be of any resolution or timing as |
| | well as any format. |
| Output Signal | The end result of the image from the invention. |
| | The output can be a video or graphic image of any |
| | resolution or timing as well as any format. |
| Scaler | A device which converts between video/graphic |
| | formats and/or resolutions/timing. Image is |
| | usually magnified or reduced in order to accom- |
| | modate new resolution and/or timing. Additional |
| | controls to handle positioning and cropping once |
| | the image is magnified or reduced are available |
| | to assist in the alignment with other displays. |
| Combiner | A device which combines 2 or more video/graphic |
| | images together to form 1 complete image |
| | comprised of the original images. |
| Rotation Engine | A device which can rotate an image in any degree |
| | increment or decrement. This device would |
| | typically rotate an image 0, 90, 180, or 270 |
| | degrees but is not necessarily limited to lesser |
| | or greater degrees of increments or decrements. |
| Content | Video or graphic information sent by a device to |
| | provide static or animated images. The information |
| | may be in a format or resolution which will need |
| | to be decoded. |
| Source | A device in which the content is derived from. |
| Matrix | A device which can direct any one of the input(s) |
| | to any of the output(s). The matrix can be of any |
| | size. One input for example can be sent to one or |
| | as many as all outputs. |
| Video Wall | Multiple video/graphic displays in close proximity |
| | used to make a single image from the content. |
| Display Device | A device which is capable of displaying video |
| | and/or graphic images. Examples of such a device |
| | might be CRT, Plasma, LCD, OLED, DLP Projection, |
| | LCD Projection, or any other technology capable of |
| | showing static or moving video/graphic images. |

### DESCRIPTION OF DRAWINGS

FIG. 1 is a display device showing normal viewing (before rotation processing) along with the X and Y locations for orientation of an image or images in relation to the mounting of the display.

FIG. 2 is an image from a source (ex. Computer, VCR, DVD, etc) before being displayed or processed. The source is represented with the text Image 1 can be of any source type. The word “image” represents the orientation of the video/graphic content on the display and applies to the other figures supplied in the description of drawings and drawings section of this patent.

FIG. 3 is the display device mounted as 90 degrees or 270 degrees compared to the 0 degree mounting as in FIG. 1. It shows what an image would look like before rotation processing if screen was rotated.

FIG. 4 demonstrates an image static or moving, being processed with the invention. With the combination of scaling, rotating, cropping, positioning and zooming, the original image is spread across 5 vertically mounted displays in a single row. The same process can be applied to an unlimited amount of display devices in a row and/or columns.

FIG. 5 demonstrates an image static or moving, being processed with the invention. With the combination of scaling, rotating, cropping, positioning and zooming, the original image is spread across 3 vertically mounted displays in a single column. The same process can be applied to an unlimited amount of display devices in a row and/or columns.

FIG. 6 demonstrates an image static or moving, being processed with the invention. With the combination of scaling, rotating, cropping, positioning and zooming, the original image is spread across 6 vertically mounted displays consisting of 3 rows and 3 columns. The same process can be applied to an unlimited amount of display devices in a row and/or columns.

FIG. 7 is a block diagram of a circuit which scales (resizes) the images first then rotates the image.

FIG. 8 is a block diagram of a circuit which rotates the images first then scales (resizes) the image.

FIG. 9 is a block diagram of a circuit which scales (resizes) the image(s) first then rotates the image(s) and outputs up to four different displays. Each display will have the appropriate magnification, and position to achieve a video wall effect from a single device using the circuit from FIG. 7. Using this circuit in a single device multiple times allows the creation of a video wall processor which is capable of achieving rotated images to make up a single image across multiple vertically mounted displays. The addition of a matrix will increase the effectiveness of such a device to direct multiple inputs as needed. The circuit can also be used independently in a device so that multiple devices can work together to achieve the effect of the vertically mounted video wall.

FIG. 10 is a block diagram of a circuit which rotates the images first then scales (resizes) the image(s) and outputs up to four different displays. Each display will have the appropriate magnification, and position to achieve a video wall effect from a single device using the circuit from FIG. 8. Using this circuit in a single device multiple times allows the creation of a video wall processor which is capable of achieving rotated images to make up a single image across multiple vertically mounted displays. The addition of a matrix will increase the effectiveness of such a device to direct multiple inputs as needed. The circuit can also be used independently in a device so that multiple devices can work together to achieve the effect of the vertically mounted video wall.

FIG. 11 is a block diagram of a circuit which scales (resizes) the image(s) first then rotates the image(s) and outputs up to four different displays. Each display will have the appropriate magnification, and position to achieve a video wall effect from a single device using the circuit from FIG. 7. This circuit is similar to FIG. 9 except it demonstrates the use of a matrix to direct any of the inputs to any of the outputs. The matrix can be inserted at almost any point in the circuit before the output as its main intent is to direct a pathway to an output for the effect.

FIG. 12 is a block diagram of a circuit which rotates the images first then scales (resizes) the image(s) and outputs up to four different displays. Each display will have the appropriate magnification, and position to achieve a video wall effect from a single device using the circuit from FIG. 8. This circuit is similar to FIG. 10 except it demonstrates the use of a matrix to direct any of the inputs to any of the outputs. The matrix can be inserted at almost any point in the circuit before the output as its main intent is to direct a pathway to an output for the effect.

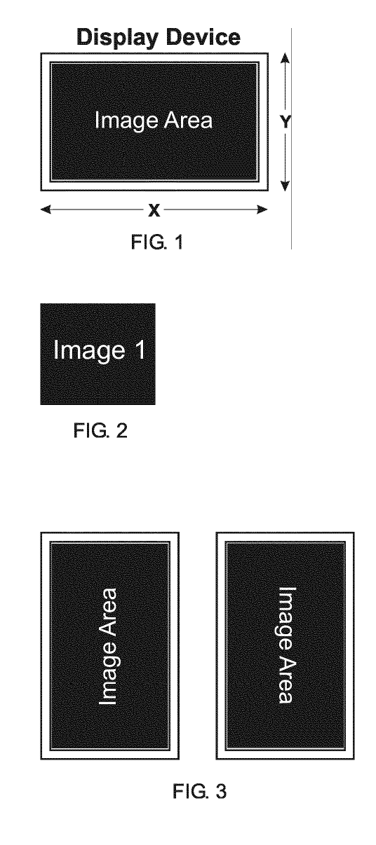

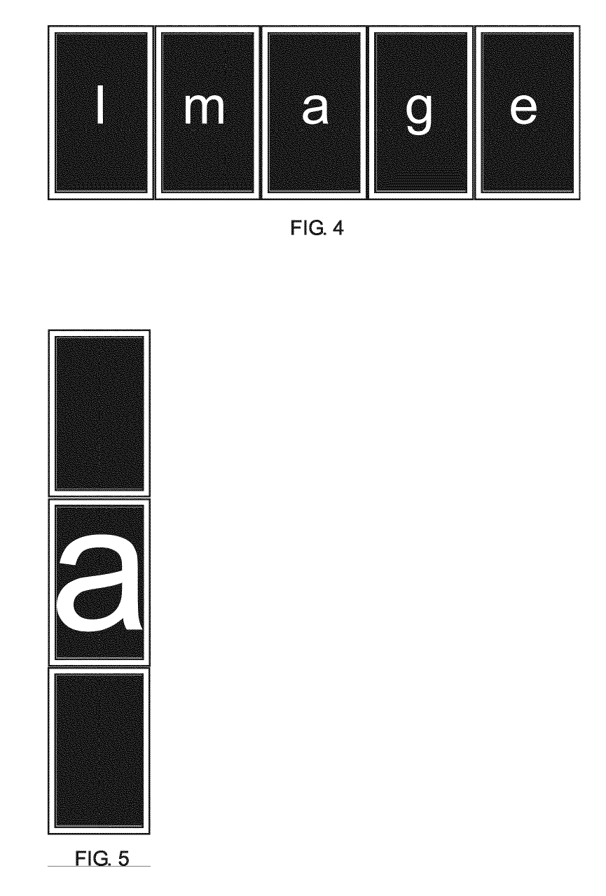

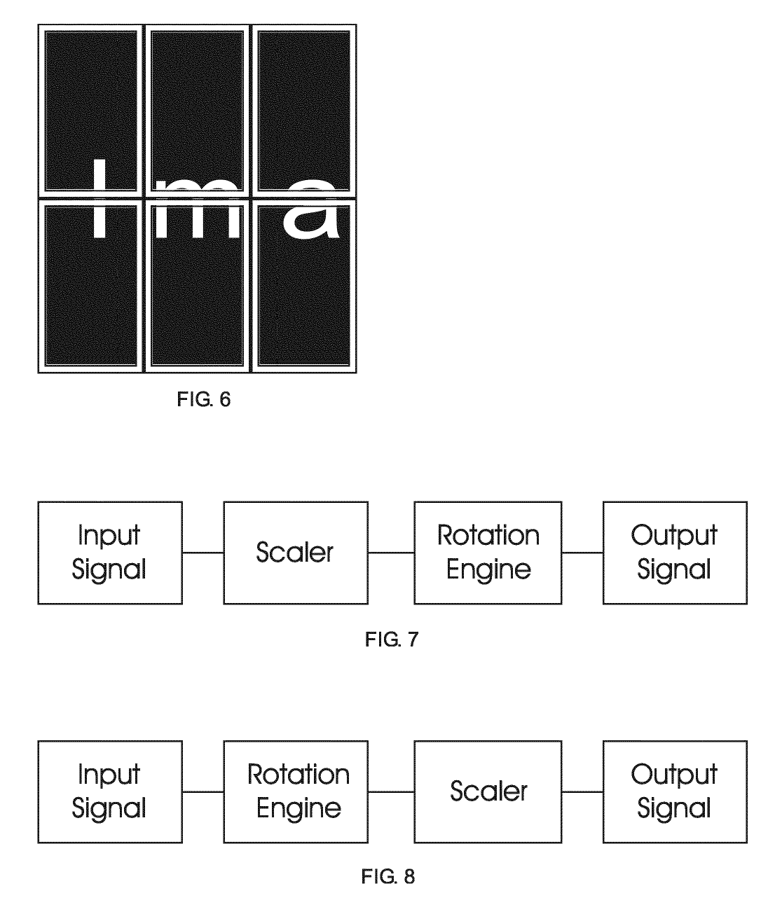

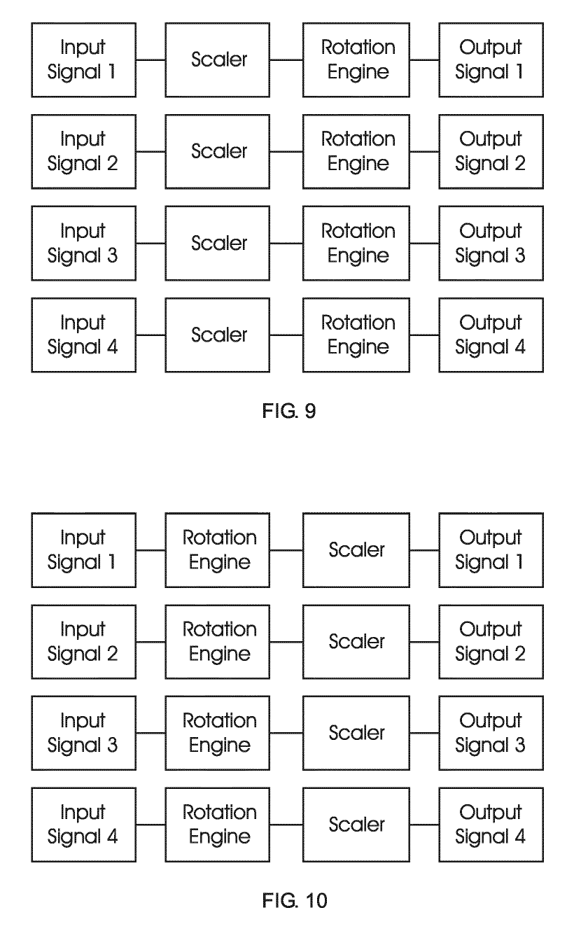

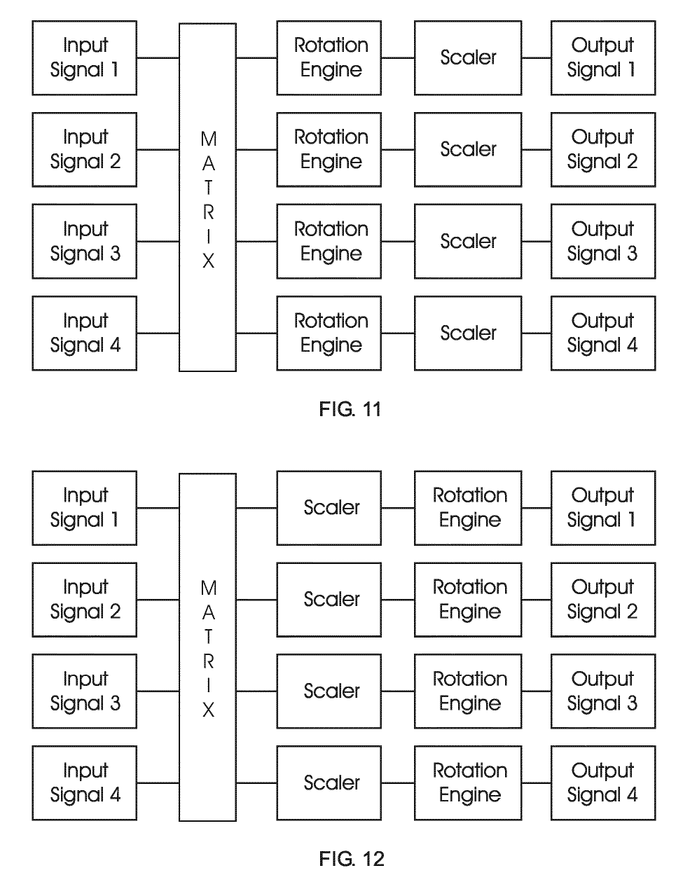

1-2. (canceled)

3. An electronic device comprising:
the ability to rotate and magnify a measured portion of a static or animated video or graphic information sent by a device in real time 90 or 270 degrees of its original orientation then retransmitted. The result is to be viewed on an individual display device mounted in a way where the vertical dimension is larger than the horizontal and adjacent to other display devices implementing the same process but with different measured portions of the same original content to form one large image across the multiple display devices.
